(19) United States
(12) Patent Application Publication
(10) Pub. No.: US 2010/0052460 A1
(43) Pub. Date: Mar. 4, 2010

(54) ELECTRICAL ROTATING MACHINE

(75) Inventors: Hidetoshi Koka, Hitachi (JP); Hiroshi Kanazawa, Hitachiota (JP); Susumu Terumoto, Numazu (JP); Masanori Nakagawa, Susono (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Kokusan Denki Co., Ltd.

(21) Appl. No.: 12/542,015

(22) Filed: Aug. 17, 2009

(30) Foreign Application Priority Data
Aug. 26, 2008 (JP) 2008-216100

(51) Int. Cl. H02K 3/04; H02K 1/12

(52) U.S. Cl. 310/195

(57) ABSTRACT

In a permanent magnet type electrical rotating machine having coils 12 with a deviated electrical angle phase at their magnetic pole positions, a relation of T2>T1 is satisfied where T1 is the number of turns of each of the coils and T2 is the number of turns of each of other coils, or alternatively a relation of R2<R1 is satisfied where R1 is a magnetic resistance of a tooth around which each of the coils is wound and R2 is a magnetic resistance of a tooth around which each of other coils is wound.

### BACKGROUND OF THE INVENTION

The present invention relates to an electrical rotating machine.

An electrical rotating machine such as a generator includes a stator having a plurality of coils and a rotor having a plurality of permanent magnets, and is structured in such a manner that rotational magnetic fields generated by the rotating permanent magnets cross the coils to generate an electromotive force across the coils.

For example, International Publication WO03/098781 discloses an electrical rotating machine with permanent magnets of a magnet field rotation type. This electrical rotating machine is structured in such a manner that three in-phase coils are arranged consecutively. The number of turns of each coil is not specified in WO03/098781. It is disclosed particularly in FIG. 6 of WO03/098781 that magnetic poles are added so that each of adjacent magnetic poles of the stator is made to be opposite a permanent magnet of a different polarity at the same electrical angle, thereby increasing effective magnetic fluxes.

### SUMMARY OF THE INVENTION

According to the techniques illustrated in FIG. 6 of WO03/098781, although the body size of an electrical rotating machine is similar to that of a conventional electrical rotating machine, this electrical rotating machine can lower a coil temperature by suppressing the amount of generated electricity in the medium to high rotational speed range, and can improve an output in the low rotation speed range.

However, because each magnetic pole is arrange to be opposite a permanent magnet at the same electrical angle, mechanical angles between the magnetic poles of the stator are not equal, but of three in-phase magnetic poles consecutively arranged, the left and right magnetic poles are displaced closer to the middle one, and hence there arises the problem that it is difficult to wind a coil around the middle magnetic pole.

On the other hand, if the magnetic poles of the stator are arranged at an equal pitch, when the middle one of the in-phase magnetic poles coincides in position with a magnetic pole of the rotor opposite it, the two magnetic poles (adjacent coils) adjacent to the middle one deviate in position from magnetic poles of the rotor opposite them. Hence, linkage fluxes linking to the adjacent coils become less than linkage fluxes linking to the middle magnetic pole. Meanwhile, there is the problem that, because a copper loss is proportional to the number of turns of the coils wound around the stator, the copper loss in the adjacent coils also increases due to the adjacent coils while linkage fluxes increase.

It is therefore an object of the present invention to provide an electrical rotating machine capable of reducing a copper loss while coils are arranged at an equal pitch.

In order to achieve the above-described object, the present invention provides a permanent magnet type electrical rotating machine having coils with a deviated electrical angle phase at their magnetic pole positions, wherein a relation of T2>T1 is satisfied where T1 is the number of turns of each of the coils and T2 is the number of turns of each of other coils.

Alternatively, in the permanent magnet type electrical rotating machine having coils with a deviated electrical angle phase at their magnetic pole positions, a relation of R2<R1 is satisfied where R1 is a magnetic resistance of a tooth around which each of the coils is wound and R2 is a magnetic resistance of a tooth around which each of other coils is wound.

According to the present invention, it is possible to reduce a copper loss to be caused by linkage fluxes, while coils are arranged at an equal pitch.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view illustrating the structure of an electrical rotating machine according to an embodiment of the present invention.

FIG. 2 is a circuit diagram of the electrical rotating machine according to the embodiment of the present invention.

FIG. 3 is a plan view illustrating the structure of a rotor.

FIG. 4 is a diagram illustrating deviation of an electrical angle when a magnetic pole center of a permanent magnet is superposed upon the middle magnetic pole.

FIG. 5 is a diagram illustrating a vector sum of the number of effective turns of in-phase coils.

FIG. 6 is a characteristic graph of losses and a generated current during low speed rotation.

FIG. 7 is a characteristic graph of an efficiency during low speed rotation.

FIG. 8 is a plan view illustrating the structure of a stator.

FIG. 9 is a diagram illustrating deviation of an electrical angle when a center of a permanent magnet is superposed upon the middle magnetic pole in a U+ phase.

FIG. 10 is a diagram illustrating a method of lowering a magnetic resistance by providing side wall plates.

### DESCRIPTION OF THE EMBODIMENTS

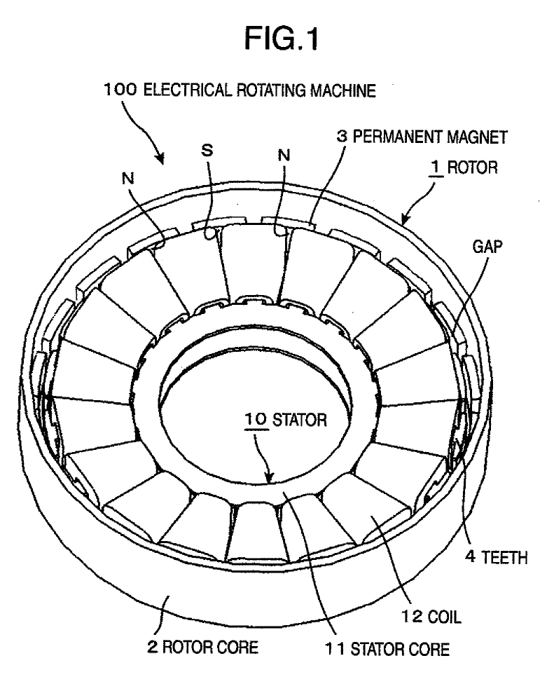

With reference to FIG. 1, description will be made on the structure of an electrical rotating machine according to an embodiment of the present invention.

Reference is made to FIG. 1 illustrating the structure of an electrical rotating machine. An electrical rotating machine 100 is of an outer rotor type with permanent magnets, and includes a rotor 1 having multiple permanent magnets 3 fixed to the inner circumferential surface of a rotor core 2, and a stator 10 having multiple coils 12 wound through slots formed in a stator core 11. Iron plates (not shown) different in thickness are disposed at the edge sides of axis direction. The stator 10 is inserted into the rotor 1 with a slight gap between the stator 10 and the inner surface of the rotor 1, and the rotor 1 is rotatably supported by a bearing (not shown) to function as a fly wheel as well.

In the rotor 1, twenty plate-shaped permanent magnets 3 are arranged on the inner surface of the rotor core 2 at an equal pitch in a circumferential direction in such a manner that N-poles alternate with S-poles. The rotor core 2 is in the shape of a shallow sleeve having a height in the axis direction shorter than its radius. The stator 10 includes the stator core 11 having a ring-shaped central portion and eighteen coils 12, which are wound around eighteen teeth 4 respectively in a concentrated manner. That is, the number of stator magnetic poles of the present embodiment is eighteen, and the number of slots is eighteen. The teeth 4 are each shaped like a T and protrude radially at an equal pitch, from the stator core 11. The rotor core 2 and stator core 11 are formed by piling electromagnetic steel plates one on top of another so as to reduce an eddy current loss, but these cores may be formed by a powder magnetic core.

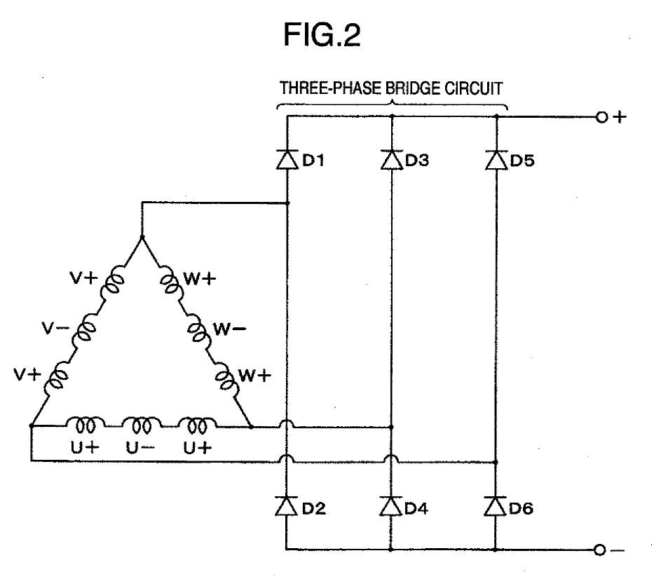

Next, the circuit configuration will be described using the circuit diagram of FIG. 2. In the electrical rotating machine 100 of the present embodiment (FIG. 1), three in-phase coils U+, U− and U+ are connected serially for each phase, and these sets of serially connected coils are connected in a Δ shape. With this configuration, as the rotor 1 rotates, rotational magnetic fluxes link to the coils 12, so that three-phase induced voltages having a 120° phase difference are generated in twelve coils 12 connected in a three-phase arrangement. The three-phase induced voltages are converted into a DC power by a three-phase bridge circuit constituted of diodes D1 to D6.

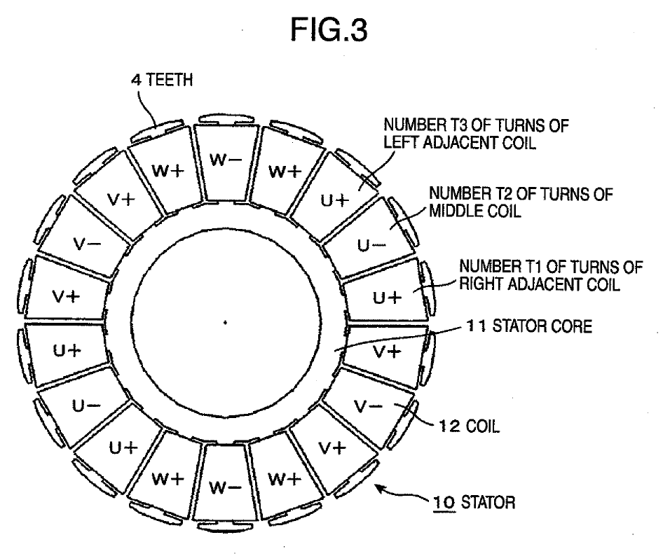

Next, the configuration of the stator 10 will be described in detail. FIG. 3 shows the stator 10 of FIG. 1 as viewed from front, where the rotor 1 is assumed to rotate counterclockwise in the plane of FIG. 3. In FIG. 3, the coils 12 wound around the teeth 4 formed on the stator core 11 are configured in such a manner that three in-phase coils for each phase are arranged consecutively in the order of U+, U−, U+, W+, W−, W+, V+, V−, V+, U+, U−, U+, W+, W−, W+, V+, V−, and V+ counterclockwise in the plane. Here, U+ and U− indicate that the winding directions of their coils are opposite. The middle coil U− of the three in-phase coils 12 is simply called a middle coil, and the number of turns thereof is denoted as T2. The coils U+ and U+ on both sides of the middle coil are called adjacent coils and the numbers of turns thereof are denoted as T1 and T3, respectively.

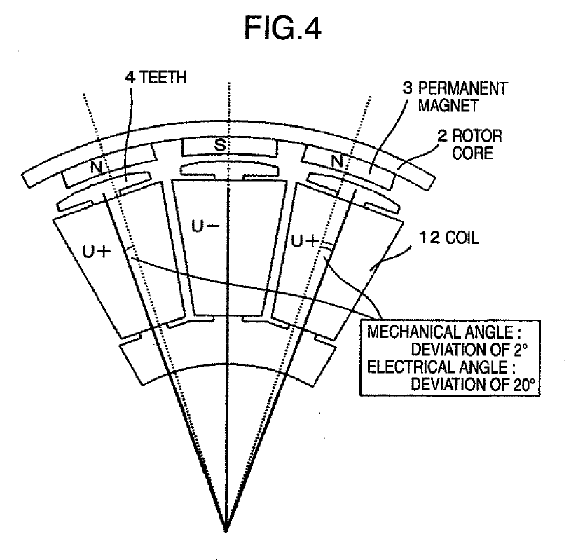

FIG. 4 shows a positional relationship between the three U−phase in-phase coils U+, U− and U+ and three permanent magnets 3 (N-pole, S-pole and N-pole), where the center lines of the middle coil U− and of the S-pole of a permanent magnet coincide. In this case, left and right adjacent coils U+ and U+ deviate by an electrical angle of 20° (2° in mechanical angle). Because the number of magnetic poles of the rotor 1 is twenty (ten pairs), an electrical angle equivalent to a mechanical angle of 360° is given by:

360°×(20/2)=3600°

This electrical angle divided by the number of teeth (number of slots) of 18 makes:

3600°/18=200°

That is, where the teeth 4 are arranged evenly in a circumferential direction, the difference in electrical angle between adjacent teeth 4 is at 200°. If this difference were at 180°, a magnetic pole would coincide in phase with the U+ phase, but in reality, there is an electrical angle deviation of 20°(=180°−160°).

The induced voltage in the coil 12 is usually proportional to linkage fluxes, i.e., the number of turns, but because the left and right adjacent coils U+ and U+ deviate by an electrical angle of 20° (2° in mechanical angle), their induced voltages become 0.940 (=cos 20°) times that of the U−phase middle coil U−. Therefore, the induced voltage generated by each of the left and right adjacent coils U+ and U+, that is, the number of effective turns, equals the number of actual turns multiplied by cos 20°. In other words, there are a place around which a coil is wound to act effectively and a place where a coil does not, depending on the location of the places.

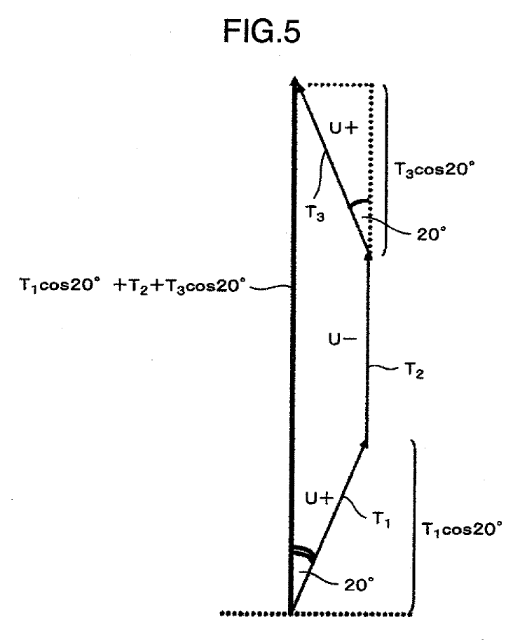

In FIG. 5, the numbers of effective turns of the coils for the case of FIG. 4 are represented in the form of a vector diagram. Let T2 be the number of turns of the middle coil U−, T1 be the number of turns of the right adjacent coil U+, and T3 be the number of turns of the left adjacent coil U+. While the number T2 of turns of the middle coil U− has no electrical angle deviation, the numbers of effective turns of the right and left adjacent coils U+ and U+ equal T1 or T3 multiplied by cos 20° to become less than the actual one. Hence, the right and left adjacent coils U+ and U+ are 6% lower in the rate of utilization than the middle coil U−. Thus, the total number of effective turns of the three in-phase coils (adjacent coil U+, middle coil U−, and adjacent coil U+) is expressed as T1·cos 20°+T2+T3·cos 20°.

In order to make the right and left adjacent coils U+ and U+ have an induced voltage similar to that of the middle coil U−, the numbers T1 and T3 of turns of the right and left adjacent coils U+ and U+ may be increased, but this results in elongating the wire rod of the coil, thus increasing a copper loss. Hence, it is desirable to secure a high induced voltage with suppressing the number of turns as much as possible. Accordingly, keeping the total number (T1+T2+T3) of turns constant, the numbers T1 and T3 of turns of the right and left adjacent coils U+ and U+, whose number of effective turns is less than the actual one, are reduced, while the number T2 of turns of the middle coil U−, whose number of effective turns equals the actual one, is increased. By this means, the induced voltage can be increased without increasing a copper loss.

Next, description will be made on a specific procedure of adjusting the number of turns. Where the middle magnetic pole coincides with the magnetic pole center of a permanent magnet, let θ1 be the electrical angle deviation of the magnetic pole located on the right in the plane of FIG. 4, θ3 by the electrical angle deviation of the magnetic pole located on the left in the plane, T1 be the number of turns of the right adjacent coil U+, T2 be the number of turns of the middle coil U−, and T3 be the number of turns of the left adjacent coil U+. In order to secure the same induced voltage, the number T2 of turns of the middle coil U− may be increased so as to satisfy the formulas (1) and (2)

T1·cos θ1+T2+T3·cos θ3=a constant (1)

T1=T3<T2 (2)

Theoretically, as the number T2 of turns of the middle coil U− increases, the induced voltage per turn increases. However, in view of mounting, the upper limit of the number T2 of turns of the middle coil U− is determined by a coil space and the winding technique.

The left and right magnetic poles may be displaced closer to the middle magnetic pole, and the number T2 of turns of the middle coil U− may be increased. For example, if magnetic poles are placed at an equal pitch, the electrical angle deviations θ1 and θ3 equal 20° and the numbers of effective turns of the right and left adjacent coils U+ and U+ equal the number of actual turns multiplied by cos 20° (=0.940). In contrast, by making the electrical angle deviations θ1 and θ3 equal to 10° (1° in mechanical angle), the numbers of effective turns of the right and left adjacent coils U+ and U+ become equal to the number of actual turns multiplied by cos 10° (=0.985), which factor is closer to 1.000. Thus, because the numbers of effective turns of the right and left adjacent coils U+ and U+ become larger, the number T2 of turns of the middle coil U− need not be so much large.

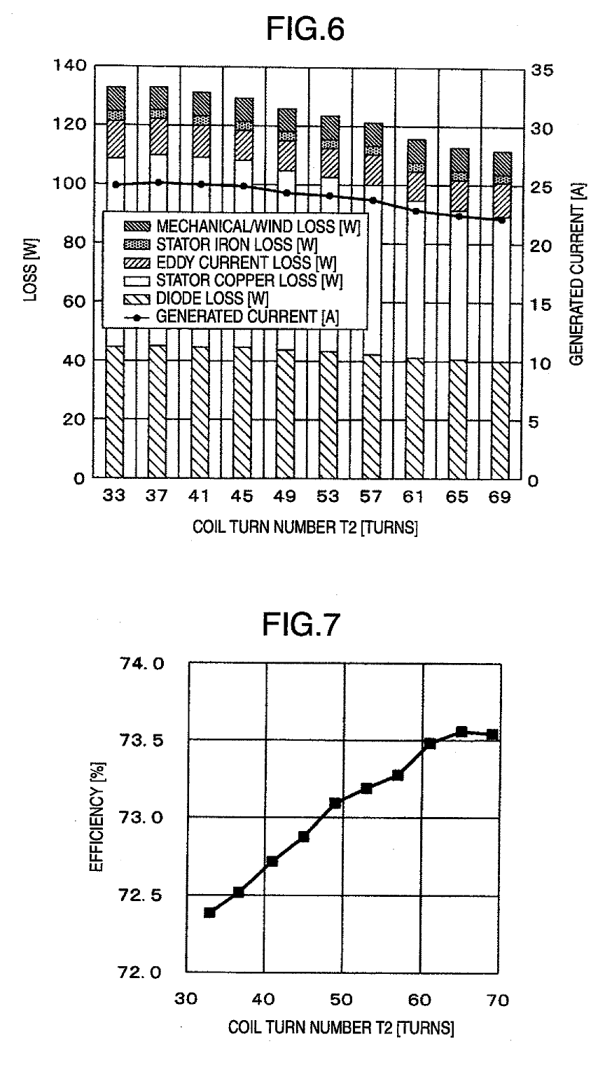

In the technique illustrated in FIG. 6 of WO03/098781, since the electrical angle deviation θ=0°, the factor is at cos 0°=1.00, and the number T2 of turns of the middle coil U− need not be increased. However, because the coil spaces (slots) on both sides of the middle coil U− are narrower as mentioned previously, a sophisticated winding technique is needed to wind a coil through the narrow spaces.

The number of turns is adjusted according to the same procedure for the V-phase and the W-phase as well as the U−phase.

As described above, in the magnetic field rotation type electrical rotating machine with permanent magnets that has the ratio of the number of magnetic poles of the rotor 1 to the number of magnetic poles of the stator 10 being at 10:9, the number T2 of turns of the middle coil can be increased while the number T1 of turns of the right coil and the number T3 of turns of the left coils are decreased. By this means, securing a necessary induced voltage, the total number (T1+T2+T3) of turns can be decreased, hence suppressing winding resistance. Thus a copper loss can be reduced.

In order to verify the effect of reducing a copper loss, an analysis was conducted according to a two-dimensional finite element method.

FIG. 6 shows a characteristic chart of various losses and a generated current at 1,200 rpm (during low speed rotation). The horizontal axis represents the number T2 of turns of the middle coil, and the vertical axes represent a loss [W] and a generated current [A]. The various losses include a mechanical/winding loss [W], a stator iron loss [W], and a diode loss [W], and are shown according to the ratios of them to the total loss.

Assuming that the rotor 1 rotates counterclockwise in the planes of FIGS. 3 and 4, the number T1 of turns of the adjacent coil U+ on the right in the plane of the figure and the number T3 of turns of the adjacent coil U+ on the left were set so as to satisfy the equations (3) and (4). When the numbers of turns of the three adjacent coils U+, U− and U+ are set to be the same, the number (T1=T2=T3) of turns is 41.

T1·cos 20°T2+T3·cos 20°=a constant (32 41·cos 20°+41+41·cos 20°=118.1=constant) (3)

T1=T3 (4)

In this case, a diode loss was about 43 [W], and a stator copper loss was about 60 [W], which accounted for a large portion of a total loss of 131 [W]. An increase in the number T2 of turns of the middle coil U− decreases the total loss from 131 W (at 41 turns) to 113 W (at 65 turns) by 13.7%, while the generated current decreased from 24.9 A (at 41 turns) to 22.4 A (at 65 turns) by a smaller amount of 10.0%.

FIG. 7 shows an efficiency [%] at 1,200 rpm (during low speed rotation). It is seen from FIG. 7 that an increase in the number T2 of turns of the middle coil increases the efficiency from 72.7% (at 41 turns) to 73.6% (at 65 turns). When the number T2 of turns is 61, the number T1=T3 of turns is 30, and when the number T2 of turns is 65, the number T1=T3 of turns is 28. In other words, a maximum efficiency is obtained at this turn ratio.

As described above, according to the present embodiment, the ratio of the number of magnetic poles of the permanent magnets 3 to the number of magnetic poles of the coils is at 10:9, and the middle coil U− and the adjacent coils U+ and U+ in-phase with the middle coil U− are arranged consecutively in a series of three. When the axis of the middle coil U− coincides in position with the magnetic pole of a permanent magnet 3 opposite the middle coil U−, the axes of the two coils U+ and U+ adjacent to the middle coil U− deviate in position by an electrical angle of 20° from the magnetic poles of the permanent magnets 3 opposite them. Hence, linkage fluxes linking to the adjacent coils U+ and U+ equal linkage fluxes linking to the middle coil U− multiplied by cos 20°. Meanwhile, because a copper loss is proportional to the total number of turns, by increasing the numbers T1 and T3 of turns of the adjacent coils U+ and U+, a copper loss can be reduced with the total linkage fluxes for the in-phase coils being maintained. Further, keeping the total number (T1+T2+T3) of turns constant, the linkage fluxes (i.e., induced voltage) can be increased without increasing a copper loss. In particular, by making the numbers T1 and T3 of turns of the adjacent coils U+ and U+ equal to the number T2 of turns of the middle coil U− multiplied by cos 20°, linkage fluxes linking to the adjacent coils U+ and U+ become equal to linkage fluxes linking to the middle coil U−.

### Modifications

The present invention is not limited to the above embodiment, but can be modified in various ways, for example, as follows.
(1) Although in the above embodiment the ratio of the number of magnetic poles of the rotor 1 to the number of magnetic poles of the stator 10 is 10:9, the ratio may be at 8:9 with similar advantages. In this case, because the number of magnetic poles of the rotor 10 is 16 (8 pairs), an electrical angle equivalent to a mechanical angle of 360° given by:

360°×(16/2)=2800°

This electrical angle divided by the number of teeth (number of slots) of 18 makes:

2880°/18=160°

That is, where the teeth 4 are arranged evenly in a circumferential direction, the difference in electrical angle between adjacent teeth 4 is at 160°. If it is assumed that the electrical angle phase of the middle coil of the three in-phase coils 12 consecutively arranged is at 0° and of the U−phase, the electrical angle phases of the left and right adjacent coils are at ±160°. If this difference is at 180°, a magnetic pole coincides in phase with the U+ phase, but in reality, an electrical angle deviation of 20° occurs as in the case of the magnetic pole number ratio being at 10:9.

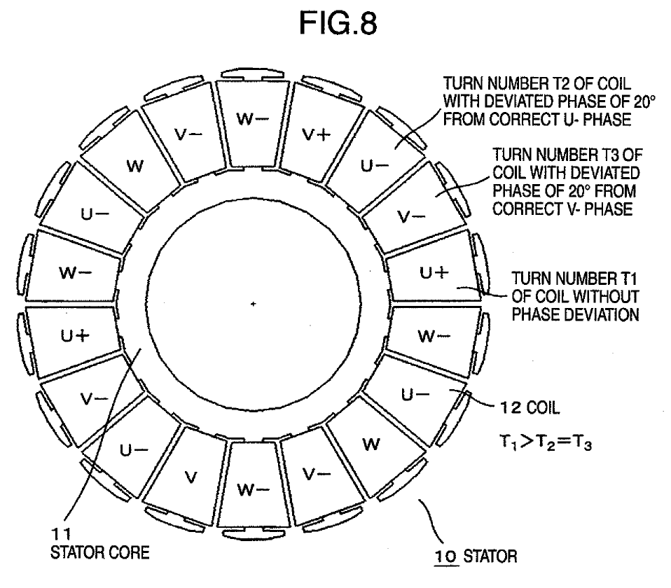

Namely, when the axis of the middle coil U− coincides in position with the magnetic pole of the permanent magnet 3 opposite it, the axes of the two adjacent coils U+ and U+ adjacent to the middle coil and the magnetic poles of the permanent magnets 3 opposite them have a deviation by an electrical angle of 20°. Therefore, induced voltages in the adjacent coils become lower than that in the middle coil U−. A copper loss is proportional to the total number of turns of the coils. Increasing the number of turns of the middle coil U− and decreasing the number of turns of the adjacent coils U+ and U+, a copper loss can be reduced while the induced voltages in all in-phase coils are maintained. Crossing magnetic fluxes, i.e., induced voltages can be increased while the total number of turns is maintained constant without increasing a copper loss.
(2) In the above embodiments a ratio of the number of magnetic poles of the rotor 1 to the number of magnetic poles of the stator 10 is set to 10:9 or 8:9 and three in-phase coils are arranged consecutively. It is not always necessary to arrange three in-phase coils consecutively. For example, in the case of a combination of 28 magnetic poles and 18 slots as shown in FIG. 8, the number of magnetic poles of the rotor 1 is 28 (14 pairs) and an electrical angle corresponding to a mechanical angle of 360° is 360°×(28/2)=5040°. This electrical angle divided by the number of teeth (number of slots) of 18 is 280°. Namely, as the magnetic poles are disposed at an equal pitch along a circumferential direction, an electrical angle difference between adjacent teeth 4 is 280°.

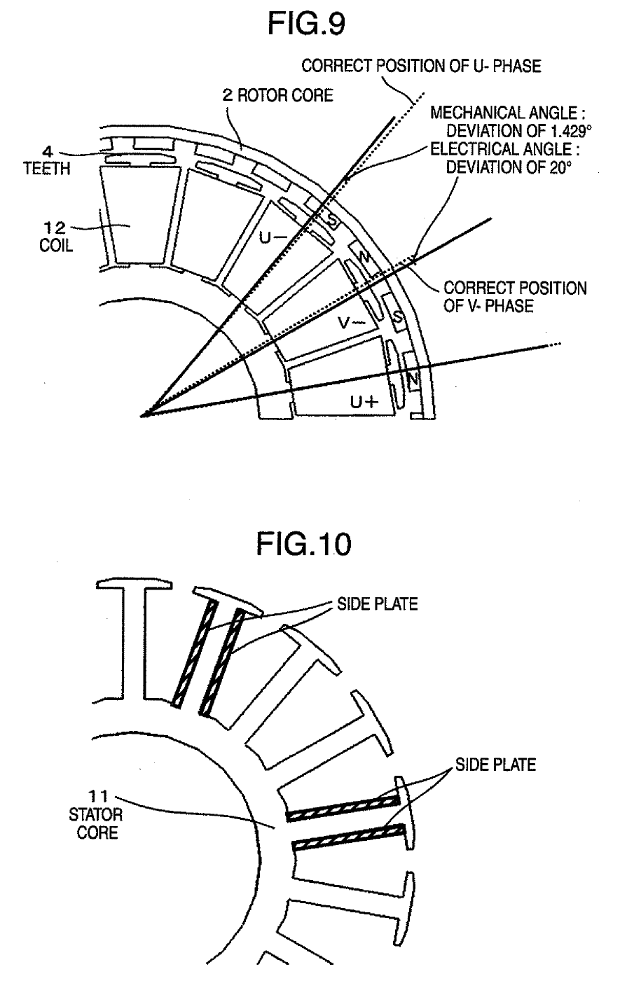

As shown in FIG. 9, assuming that an electrical angle phase of an arbitrary coil is 0° in the U+ phase, an electrical angle phase of adjacent coils is 280°. If there is phase deviation of 270° to 330° from the U phase, this phase is defined as a V− phase. However, there is an electrical angle deviation of 20° from the correct V− phase of 300°.

An electrical angle phase of the next coil is 280°×2=560°, i.e., 200°. If there is deviation of 150° to 210° from the U phase, this phase is defined as a U−phase. However, there is an electrical angle deviation of 20° from the correct U− phase of 180°.

Namely, when the axis of an arbitrary coil coincides in position with the magnetic pole of the permanent magnet 3 opposite it, there is deviation of the electric angle phase of the adjacent coils from a correct electrical angle phase. Therefore, induced voltages lower than that to be otherwise induced. To compensate for this, the number of turns of the coil with electrical angle phase deviation is decreased and the number of turns of the coil without electrical angle deviation is increased. In this manner, a copper loss can be reduced while maintaining the induced voltages of all coils. Crossing magnetic fluxes, i.e., induced voltages can be increased while the total number of turns is maintained constant without increasing a copper loss.

Advantages similar to the embodiment can be obtained not only for embodiments described in (1) and (2) but also for various patterns of ratios of the number of magnetic poles of the rotor 1 to the number of magnetic poles of the stator 1.
(3) Although in the above embodiment the electrical rotating machine 100 is used as a generator, the electrical rotating machine 100 can be used as a motor. In this case, applying three-phase voltages to the coils 12 connected in a Δ shape generates a rotational magnetic filed, so that the rotor 1 rotates. Further, although the above embodiment is of an outer rotor type where the stator 10 is inserted into the rotor 1, the electrical rotating machine may be of an inner rotor type where a rotor is inserted into a stator.
(4) In the above embodiment, although three-phase voltages are assumed, the embodiment is applicable to an electrical rotating machine of other phases such as four-phase, and five-phase.
(5) In the above embodiment, an efficiency is improved by adjusting the number of turns. Instead, the teeth for passing magnetic fluxes crossing the coil without phase deviation may be made thick as shown in FIG. 10. Alternatively, material having a high permeance may be used for the teeth winding coils without phase deviation to reduce magnetic resistance and increase magnetic fluxes crossing the coils without phase deviation, thereby improving an efficiency of an electric rotating machine.
(6) Although in the above embodiment permanent magnets are used for the rotor so as to generate magnetic fields, windings may be used to generate magnetic fields. For example, in a tandem rotor (an inner rotor) as shown in FIGS. 15 and 16 of JP-A-2007-259575, field currents are supplied to field windings via slip rings, and the field currents generate magnetic fields.

It should be further understood by those skilled in the art that although the foregoing description has been made on embodiments of the invention, the invention is not limited thereto and various changes and modifications may be made without departing from the spirit of the invention and the scope of the appended claims.

1. An electrical rotating machine having coils with an electrical angle phase at a magnetic pole position deviated from an electrical angle phase at a magnetic pole position of a permanent magnet, wherein:
a relation of T2>T1 is satisfied where T1 is the number of turns of each of said coils and T2 is the number of turns of each of other coils.

2. An electrical rotating machine having coils with an electrical angle phase at a magnetic pole position deviated from an electrical angle phase at a magnetic pole position of a permanent magnet, wherein:
a relation of R2<R1 is satisfied where R1 is a magnetic resistance of a tooth around which each of said coils is wound and R2 is a magnetic resistance of a tooth around which each of other coils is wound.
